(19) United States
(12) Patent Application Publication
(10) Pub. No.: US 2018/0203921 A1
(43) Pub. Date: Jul. 19, 2018

(54) SEMANTIC SEARCH IN DOCUMENT REVIEW ON A TANGIBLE USER INTERFACE

(71) Applicant: Xerox Corporation, Norwalk, CT (US)

(72) Inventors: Caroline Privault, Montbonnot-Saint-Martin (FR); Ngoc Phuoc An Vo, Grenoble (FR); Fabien Guillot, Vaulnaveys-le-Haut (FR)

(73) Assignee: Xerox Corporation, Norwalk, CT (US)

(21) Appl. No.: 15/407,507

(22) Filed: Jan. 17, 2017

(51) Int. Cl. G06F 17/30; G06N 99/00

(52) U.S. Cl. CPC G06F 17/30637; G06N 99/005; G06F 17/30011

(57) ABSTRACT

An apparatus and a method increase data exploration and facilitate changing between exploratory and iterative searching. A virtual widget is movable on a display device in response to detected user gestures. Graphic objects are displayed on the display device, representing respective documents in a search document collection. The virtual widget is populated with a first query term, which can be used for an iterative search. Semantic terms that are predicted to be semantically related to it are identified, based on a computed similarity between multidimensional representations of terms in a training document collection. The multidimensional representations are output by a semantic model which takes into account context of the respective terms in the training document collection. A user selects one of the set of semantic terms for generating a semantic query for an exploratory search. Documents in the search document collection that are responsive to the semantic query are identified.

### BACKGROUND

The exemplary embodiment relates to document searching, classification, and retrieval. It finds particular application in connection with an apparatus and method for performing exploratory searches in large document collections.

There are many instances where exploratory searches are conducted in a document collection, for example to establish the search criteria for finding relevant information. Designing searches can be a complex task, since the task description is often ill-defined. In some cases, the task is broad or under-specified. In others, it may be multi-faceted. Tasks may also be dynamic in that the relevance, information needs, or targets may evolve over time. Similarly, the searcher's understanding of the problem often evolves as results are gradually retrieved. The searchers' knowledge of the domain or terminology may be insufficient or inadequate at the start of the search, but develop as the search progresses. See, for example, Wildemuth, et al., “Assigning search tasks designed to elicit exploratory search behaviors,” Proc. Symp. on Human-Computer Interaction and Information Retrieval (HCIR '12), pp. 1-10 (2012).

An exploratory search may thus include different kinds of information-seeking activities, such as learning and investigation. Marchionini, “Exploratory search: from finding to understanding,” Communications of the ACM, 49(4) 41-46, 2006. In practice, searchers may be engaged in different parts of the search in parallel, and some of these activities may be embedded into others. Two interdependent phases may occur, alternating in a cyclical manner during the search process. The first is an iterative search phase directed to a systematic lookup, e.g., searching by attributes or simple keywords. This phase is sometimes referred to as a goal-directed search, routine-based review, or systematic review. The second phase is an exploratory search phase, which entails an expansion of the search to new areas or new groups of data, sources or domain of information, or to the development of new search criteria. As opposed to systematic review, it is supported by experimental and investigative behaviors. See, e.g., Janiszewski, “The influence of display characteristics on visual exploratory search behavior,” J. Consumer Res., 25(3) 290-301, 1998. An exploratory search may evolve over time, but needs to be ready to defer to goal-directed search routines while active, and vice versa, in a cyclical manner.

The development of search tools and interfaces to support exploratory search activities faces a range of design challenges. Some tools focus on visualization and interaction, e.g., by visualizing and navigating into graphs or networks of data and their relationships. See, Chau, et al. “APOLO: making sense of large network data by combining rich user interaction and machine learning,” Proc. SIGCHI Conf. on Human Factors in Computing Systems, ACM, pp. 167-176, 2011. Other tools provide relevance feedback in a dynamic and interactive manner, as described in di Sciascio, et al., “Rank as you go: User-driven exploration of search results,” Proc. 21st Intl Conf. on Intelligent User Interfaces, ACM, pp. 118-129, 2016; and Reiterer, et al., “INSYDER: a content-based visual-information-seeking system for the web,” Intl J. on Digital Libraries, pp. 25-41, 2005. In another approach, methods for aiding search systems in identifying the nature of a user's search activity (exploratory or lookup) were developed in order to adapt the search online to the user's behaviors. See, Athukorala, et al., “Is Exploratory Search Different? A Comparison of Information Search Behavior for Exploratory and Lookup Tasks,” JASIST, pp. 1-17, 2015.

In general, these studies indicate that there is a need for search systems to increase the level of explorative search versus iterative search. Otherwise, users tend to engage in exploring and learning from the data set in a rather limited way, even when advanced user interface layout and features are provided. It would be advantageous to have search tools that encourage users to engage in exploratory phases, and that facilitate the switch between lookup and exploratory phases. The expected benefit for the users is to increase information discovery and learning from the data set.

Recently, search interfaces have been designed for use on multitouch devices, such as smart phones, tablets, and large touch surfaces. See, for example, Li, “Gesture search: a tool for fast mobile data access,” Proc. UIST, ACM, pp. 87-96, 2010; Klouche, et al., “Designing for Exploratory Search on Touch Devices,” Proc. 33rd Annual ACM Conf. on Human Factors in Computing Systems (CHI 2015), pp 4189-4198, 2015; and Coutrix, et al., “Fizzyvis: designing for playful information browsing on a multitouch public display,” Proc. DPPI, ACM, pp. 1-8, 2011. Visual and touch-based interactions are especially well suited to support knowledge workers in learning about the information space, identifying search directions, and running collaborative information seeking tasks. A specific system design associated with touch capabilities could lead to more active search behaviors, overall directing exploration to unknown areas and increasing the level of exploration during a search session.

### INCORPORATION BY REFERENCE

The following references, the disclosures of which are incorporated herein in their entireties by reference, are mentioned:
U.S. Pat. No. 8,165,974, issued Apr. 24, 2012, entitled SYSTEM AND METHOD FOR ASSISTED DOCUMENT REVIEW, by Caroline Privault, et al.
U.S. Pat. No. 8,860,763, issued Oct. 14, 2014, entitled REVERSIBLE USER INTERFACE COMPONENT, by Caroline Privault, et al.
U.S. Pat. No. 8,756,503, issued Jun. 17, 2014, entitled QUERY GENERATION FROM DISPLAYED TEXT DOCUMENTS USING VIRTUAL MAGNETS, by Caroline Privault, et al.
U.S. Pat. No. 9,037,464, issued May 19, 2015, entitled COMPUTING NUMERIC REPRESENTATIONS OF WORDS IN A HIGH-DIMENSIONAL SPACE, by Tomas Mikolov, et al.
U.S. Pat. No. 9,405,456, issued Aug. 2, 2016, entitled MANIPULATION OF DISPLAYED OBJECTS BY VIRTUAL MAGNETISM, by Caroline Privault, et al.

U.S. Pub. No. 20090100343, published Apr. 16, 2009, entitled METHOD AND SYSTEM FOR MANAGING OBJECTS IN A DISPLAY ENVIRONMENT, by Gene Moo Lee, et al.
U.S. Pub. No. 20150370472, published Dec. 24, 2015, entitled 3-D MOTION CONTROL FOR DOCUMENT DISCOVERY AND RETRIEVAL, by Caroline Privault, et al.

### BRIEF DESCRIPTION

In accordance with one aspect of the exemplary embodiment, a method for dynamically generating a query includes providing a virtual widget which is movable on a display device of a user interface in response to detected user gestures on or adjacent to the user interface. A set of graphic objects is displayed on the display device, each of the graphic objects representing a respective text document in a search document collection. Provision is made for a user to populate the virtual widget with a first query term. A set of semantic terms that are predicted to be semantically related to the first query term is identified, based on a computed similarity between a multidimensional representation of the first query term and multidimensional representations of terms occurring in a training document collection. The training document collection includes documents from at least one of: a) the search document collection and b) another document collection. The multidimensional representations are output by a semantic model which takes into account context of the respective terms in the training document collection. Provision is made for a user to select one of the set of semantic terms predicted to be semantically related. Documents in the search document collection that are responsive to a semantic query that is based on the selected semantic term are identified. The identified documents including documents containing at least one occurrence of the semantic term associated with the semantic query.

One or more steps of the method may be performed with a processor.

In accordance with another aspect of the exemplary embodiment, a system for dynamically generating a query includes a user interface comprising a display device for displaying text documents stored in associated memory and for displaying at least one virtual widget. The virtual widget is movable on the display, in response to user gestures relative to the user interface. Memory stores instructions for generating a first query based on a user-selected first query term displayed on the display device, populating a virtual widget with the first query, and conducting a search for documents in a search document collection that are responsive to the first query. Instructions are also stored for generating a semantic query, populating a virtual widget with the second query, and conducting a search for documents in the search document collection that are responsive to the semantic query. The generating of the semantic query includes identifying a set of semantic terms that are predicted to be semantically related to the first query term, based on a computed similarity between a multidimensional representation of the first query term and multidimensional representations of terms occurring in a training document collection. The training document collection includes documents from at least one of the search document collection and another document collection. The multidimensional representations are output by a semantic model which takes into account context of the respective terms in the training document collection. A processor in communication with the memory implements the instructions.

In accordance with another aspect of the exemplary embodiment, a method for dynamically generating queries includes generating a semantic model. This includes learning parameters of the semantic model for embedding terms based on respective sparse representations. The sparse representations are each based on contexts in which the respective term is present in a training document collection. Provision is made for a user to select a first query term using a user interface, for generating a first query based on the first query term, and for displaying a first set of graphic objects on the user interface that represent documents in a search document collection that are responsive to the first query. A set of semantic terms is identified. The identifying includes computing a similarity between an embedding of the query term, generated with the semantic model, and embeddings of terms in the document collection, generated with the semantic model. The set of semantic terms includes terms in the document collection having a higher computed similarity than other terms in the document collection. A semantic query is generated, based on a user selected one of the set of semantic terms. A second set of graphic objects is displayed on the user interface that represent documents in a search document collection that are responsive to the semantic query. A virtual widget is provided which is movable on the user interface in response to detected user gestures on or adjacent to the user interface. The virtual widget has a first displayable side with which the user causes a search for responsive documents to be conducted with the first query term and a second displayable side with which the user causes a search to be conducted with the semantic query term, only one of the sides being displayed at a time.

### BRIEF DESCRIPTION OF THE DRAWINGS

FIG. 1 is a functional block diagram of an exemplary apparatus incorporating a user interface in accordance with one aspect of the exemplary embodiment;

FIG. 2 illustrates a method for semantic search in accordance with another aspect of the exemplary embodiment;

FIG. 3 illustrates part of method of FIG. 2 in accordance with one aspect of the exemplary embodiment;

FIG. 4 is a top view of the user interface of FIG. 1, illustrating the process of populating a virtual magnet with a search query;

FIG. 5 is a top view of the user interface of FIG. 1, illustrating the retrieval of responsive documents from a collection with the virtual magnet;

FIG. 6 is a top view of the user interface of FIG. 1 illustrating the process of manually classifying a selected document;

FIG. 7 is a top view of the user interface of FIG. 1 illustrating the process of populating a virtual magnet with a new search query based on content of a selected document;

FIG. 8 is a screenshot illustrating display of semantically similar terms to a query term;

FIG. 9 is a screenshot illustrating populating a magnet with a query based on one or more if the displayed semantically similar terms;

FIG. 10 illustrates a magnet displaying a preselected set of user-selectable terms for populating a magnet;

FIG. 11 illustrates virtual flipping a magnet over to switch between keyword and semantic searching;

FIG. 12 illustrates aspects of a semantic search process; and

FIG. 13 illustrates generation of a semantic model in accordance with one aspect of the exemplary embodiment.

### DETAILED DESCRIPTION

A system and method are provided which can support searchers in conducting exploratory searches on large collections of documents using a Tactile User Interface (TUI). The system incorporates text processing tasks, workflows and user interface functional elements.

In the exemplary embodiment, textual elements of a document collection are each represented by a semantic representation. A semantic widget, associated with the TUI allows the user to retrieve semantic terms (related/similar terms) based on the semantic representation, and to navigate in the document set by populating a widget (which can be a different widget) with the related terms. As used herein, a “semantic term” is a term (a sequence of at least one words) that is predicted to be semantically related to a query based on a measure of similarity between respective semantic representations. As used herein, a “semantic representation” is a multidimensional representation of a term that takes into account the context (e.g., surrounding words) of the term in a selected document collection.

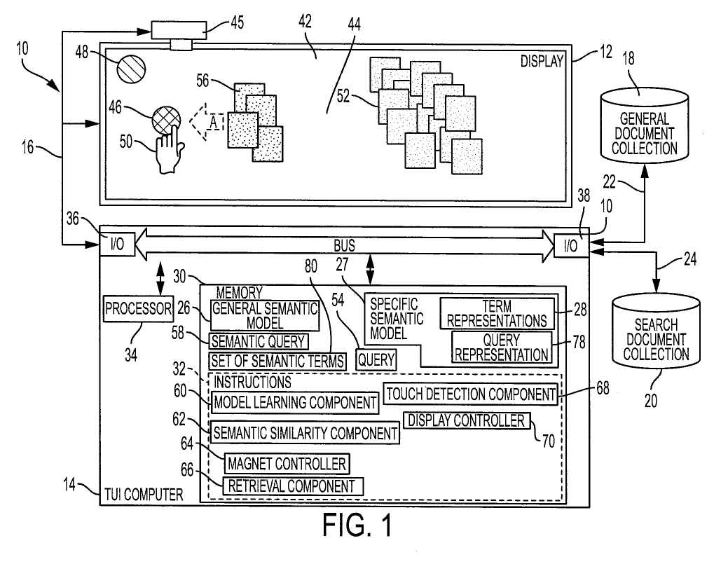

With reference to FIG. 1, a system 10 for semantic relatedness-based searching is illustrated. The system includes a user interface 12, such as a tactile user interface, and a computer 14 which controls the operation of the user interface 12 and receives information therefrom via a wired or wireless link 16. The computer may have access to a general collection 18 of text documents and to a search collection 20 of text documents, e.g., via wired or wireless links 22, 24. The general collection 18 is not limited to documents that may be relevant to the search. Documents in the general collection 18 and/or or search document collection 20 are used to learn a semantic model 26, 27, respectively, such as a word2vec neural network, which generates and stores a semantic representation (multidimensional embedding vector) 28 for each of set of terms in the respective collection 18, 20. The representations take into account the context (e.g., surrounding words) of the respective terms in the document collection.

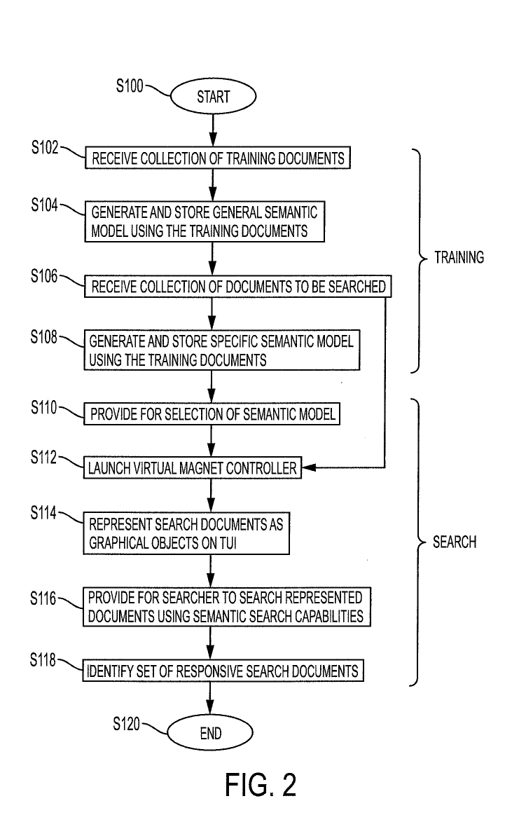

The computer 14 includes memory 30 which stores the semantic model(s) 26, 27 and instructions 32 for performing the method described with reference to FIG. 2. A processor 34, in communication with the memory 30, executes the instructions 32. Input/output devices 36, 38 allow the computer 14 to communicate with external devices, such as the TUI 12 and external memories which store the document collections 18, 20. Hardware components of the computer are communicatively connected by a data/control bus 40.

The TUI 12 includes a display device 42 and a device capable of detecting recognizable gestures by a user, such as a touch-sensitive screen 44, which detects touch gestures on the screen made by a user's finger or other physical object, as described, for example, in U.S. Pat. Nos. 8,860,763 and 8,756,503, and/or a 3D-motion sensor 45 positioned adjacent the display device, which detects hand movements by a user on or adjacent to the user interface, as described in U.S. Pub. No. 20150370472. The display device is configured for displaying one or more visual widgets 46, 48, which are movable across the display screen 44 in response to touch gestures or other recognizable user gestures, e.g., made with a finger 50, or other physical object. The widgets 46, 48 are referred to herein as virtual magnets since they have the ability to cause visual objects to move with respect to the magnet in a manner similar to the attraction/repelling properties of real magnets. Graphic objects 52, representative of the text documents in the search collection, are also displayed, e.g., as tiles or thumbnail images, which may be arranged in a wall and/or in a stack. Any number of graphic objects 52 may be displayed on the display device 42 at a given time, such as 10, 20, 50 or more graphic objects 52, or up to the total number of documents in the search collection.

In the illustrated embodiment, a first of the magnets 46 serves as a keyword query magnet, which is associated, in computer memory 30, with a search query 54 generated through the TUI 12. The graphic objects 56 representing a subset of the documents in the collection 20 that are responsive to the keyword query 54 are caused to exhibit a response to the magnet 46, e.g., by moving across the screen, in a direction shown by arrow A, towards the magnet 46, and thus may have the visual appearance of magnetic objects moving towards a magnet. Various touch gestures are used to associate the magnet with the query and to initiate the search on the displayed collection. Other magnets, such as second magnet 48, may be associated with other queries and/or may be combined with the first magnet 46 to form a compound query. In the illustrative embodiment, the second magnet 48 is associated, in memory, with a semantic query 58 that is built with similar terms generated by the semantic model 26 or 27. The second magnet 48 causes visual objects 52 whose documents are responsive to the semantic query to exhibit a response to the magnet 48 in a similar manner to the first magnet 46. However, fewer or more than two virtual magnets may be employed.

As will be appreciated the magnets 46, 48 and objects 52, 56 are all virtual rather than tangible objects, which each correspond to a set of pixels on the screen.

The illustrated instructions 32 include a semantic model learning component 60, a semantic similarity component 62, a magnet controller 64, a retrieval component 66, a touch detection component 68 and a display controller 70. These last two components may form a part of a standard software package for the system.

The semantic model learning component 60 learns a semantic model 26, 27 using a collection of documents. Models 26, 27 are generated off-line, before they can be used during search sessions, and same models can be used for several different searches on several different collections. As will be appreciated, the semantic model learning component 60 may be on a separate computing device, although for ease of illustration is shown on computer 14. In one embodiment, the model is a general semantic model 26 built using the training document collection 18. In another embodiment, the semantic model is a search-specific semantic model 27, which is based only on the documents in the search document collection 20, or a subset thereof. The semantic model 26, 27 stores an embedding vector 28 for each of a set of word sequences (terms) found in the respective document collection 18, 20.

The semantic similarity component 62 identifies a set of words that are semantically related to the query 54, based on the similarity of the semantic representation 78 of the query 54 and the semantic representations 28 of other terms stored in the model 26 and/or 27. Given a query word 54 or more generally, a query term comprising a sequence of one or more words, the model 26, 27 is accessed to retrieve the corresponding semantic representation 78 of the query term. The similarity component 62 computes on-the-fly (or retrieves from memory) a measure of similarity between the semantic representation 78 and multidimensional semantic representations 28 of other single and/or multiword terms stored in the semantic model 26 and/or 27. A set of semantic terms 80 having the highest computed similarity between the respective multidimensional semantic representations 78, 28 may be output to the display 42 for review by the searcher.

In some embodiments, e.g., due to memory requirements, one or more of the semantic model(s) 26, 27 may be stored on a linked server computer (not shown), which is accessible to the system 10. In this embodiment, the semantic similarity component 62 may send a request to the remote server computer, which performs the similarity computations and returns the results, e.g., a similarity measure or a set of semantic terms 80 that are predicted to be semantically related to the query. In this way, a single server computer may provide similarity computation services to several TUI computers 14.

The magnet controller 64 allows a searcher to specify a semantic query 58 by selecting one or more of the displayed semantic terms 80 of similar meaning to the input query 54 and to associate a magnet with the semantic query 58, such as the first or second magnet 46, 48, through a sequence of touch gestures. Other functions of the magnet controller may be as described in above-mentioned U.S. Pat. No. 8,860,763, and are briefly summarized below.

The retrieval component 66 queries the search document collection 20 using the user-selected input query 54 or semantic query 58 to identify a subset of relevant documents, which causes the corresponding tiles 56 to exhibit a response to the magnet, and/or causes responsive text fragments in an open one of the documents to be displayed, given an appropriate touch gesture.

The touch detection component 68 receives signals from the touch-sensitive display screen 44 and associates them with a set of predefined touch gestures stored in memory, including touch gestures that are recognized by the magnet controller 64. The display controller 70 renders the objects 52 and magnets 46, 48 on the display screen.

The computer-implemented system 10 may include one or more computing devices 14, such as a PC, such as a desktop, a laptop, palmtop computer, portable digital assistant (PDA), server computer, cellular telephone, tablet computer, pager, combination thereof, or other computing device capable of executing instructions for performing the exemplary method.

The memory 30 may represent any type of non-transitory computer readable medium such as random access memory (RAM), read only memory (ROM), magnetic disk or tape, optical disk, flash memory, or holographic memory. In one embodiment, the memory 30 comprises a combination of random access memory and read only memory. In some embodiments, the processor 34 and memory 30 may be combined in a single chip. Memory 30 stores instructions for performing the exemplary method as well as the processed data.

The network interface 36, 38 allows the computer to communicate with other devices via a computer network, such as a local area network (LAN) or wide area network (WAN), or the internet, and may comprise a modulator/demodulator (MODEM) a router, a cable, and/or Ethernet port.

The digital processor device 34 can be variously embodied, such as by a single-core processor, a dual-core processor (or more generally by a multiple-core processor), a digital processor and cooperating math coprocessor, a digital controller, or the like. The digital processor 34, in addition to executing instructions 32 may also control the operation of the computer 14.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or the like, and is also intended to encompass so-called “firmware” that is software stored on a ROM or the like. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

FIG. 2 illustrates a method for semantic relatedness-based searching which may be performed with the system of FIG. 1. The method begins at S100. The method includes a training stage, which is generally performed offline, and a querying phase, which uses the pre-generated semantic model(s) 26, 27.

At S102, a general collection 18 of training documents is received and stored in computer memory, such as memory 30.

At S104, a general semantic model 26 (e.g., a word2vec model) is generated using the training documents in the general collection 18 which includes, for each of a set of terms present in the documents of the general collection, generating a respective embedding vector.

At S106, a search document collection 20 to be searched is received and stored in computer memory, such as memory 30. Each document in the collection 20 may be indexed according to the terms from the set that it contains.

At S108, a specific semantic model 27 (e.g., a word2vec model) may be generated using the documents in the search document collection 20 which includes, for each of a set of terms in the documents, generating a respective embedding vector, in a similar manner to that used for generating the embedding vectors for the general collection, the embedding vectors having the same (or a different) number of dimensions as the embedding vectors generated for the general collection. If more than one semantic model 26, 27 is generated, provision may be made at S110 for one of the semantic models to be selected and loaded into accessible memory.

At S112, the virtual magnet controller 64 is launched, e.g., when the application is started, which causes the processor to implement the magnet's configuration file, or is initiated by the user tapping on or otherwise touching one of the displayed virtual magnets 46, 48.

At S114, during a search for relevant documents in the collection 20, at least some of the documents are represented, on the TUI by a corresponding graphic object in a set of graphic objects, e.g., as a two-dimensional array of tiles or as a stack of tiles. Each of the displayed objects in the set 52 is linked, in memory, to the respective document in the collection 20.

At S116, the searcher conducts a search of the documents by manipulating the displayed objects 52 and using the magnet(s) as a tool to facilitate the development of the search and retrieve relevant documents. This may be an iterative process, including an iterative search phase, in which documents are viewed to identify relevant search terms, and an exploratory phase in which the identified search terms are used to identify relevant documents, which in the illustrative case includes semantic searching with a semantic query 58.

At S118, a set of responsive documents may be identified. The identified documents include documents containing at least one occurrence of the semantic term associated with the semantic query. This step may include causing a subset of the displayed graphic objects to exhibit a response to the semantic query magnet, as a function of the semantic query and text content of respective documents which the graphic objects represent and/or cause responsive instances of the semantic query to be displayed in an open one of the responsive documents.

The method ends at S120.

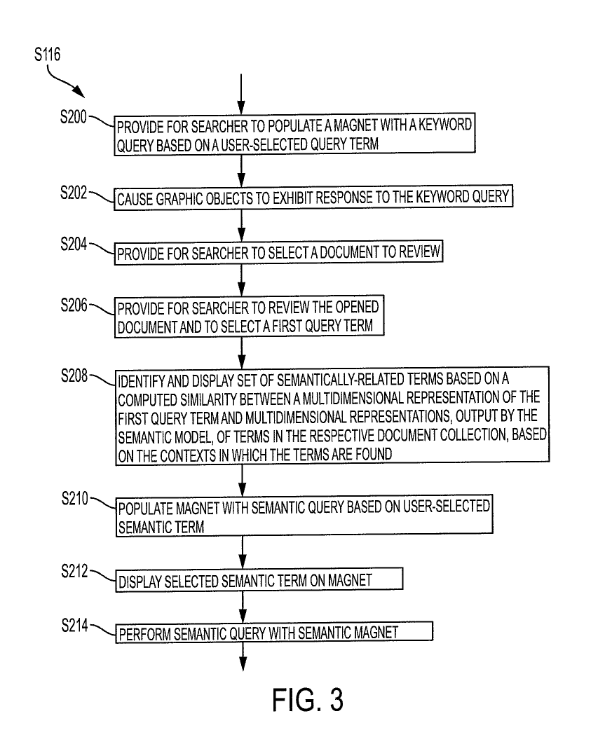

FIG. 3 illustrates the progress of an exploratory search which may be performed at S116.

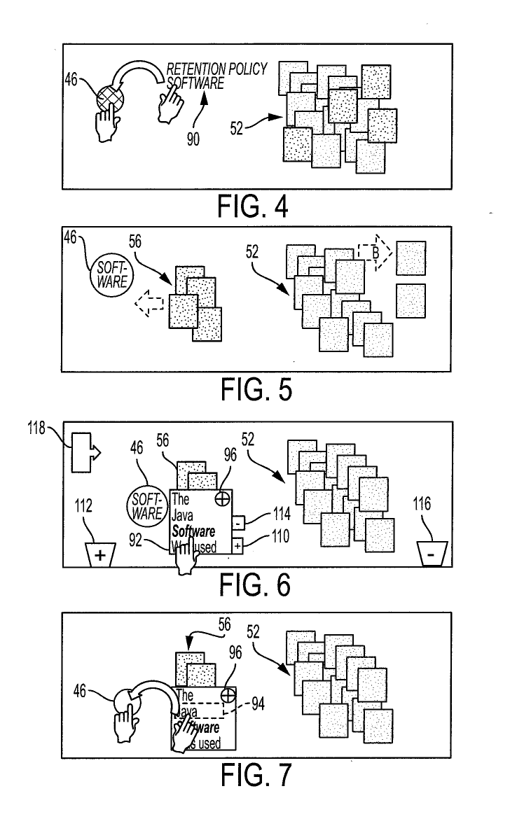

At S200, provision is made for the searcher to populate a magnet 46 with a query term 90. FIG. 4). The query term may be selected from a predefined set, e.g., displayed on the screen, accessed through a menu, highlighted in a document, or input by a user using a user input mechanism, such as by typing on a virtual or real keyboard or by speaking the query term, which is received by a microphone associated with the TUI and converted to text using appropriate speech to text software. The input query term is then displayed on the screen. A touch gesture, such as a two finger bridge, causes the keyword or other query term to be displayed on the magnet 46.

At S202, in response to a touch gesture, such as a tap on the magnet 46, and/or moving the magnet widget 46 close to the search documents 52, the tiles 56 representing the responsive documents exhibit a response to the magnet, e.g., by moving towards the magnet (FIG. 5). In some embodiments, non-responsive documents may move away from the magnet.

At S204, provision is made for the searcher to select a document to review. For example, the searcher may select one of the objects at random for review or otherwise select a document from the responsive set 56. A double touch, or other gesture, opens the selected graphic object to display the text 92 of the underlying text document (FIG. 6) in a document view mode.

At S206, provision is made for the searcher to review the opened document and to select a first query term 94 (less than all) of the text document which is to be used to generate a new query (FIG. 7). For example, the user taps a highlighting button 96 on the displayed document frame 92 or on its external border, which allows the user to select the first term 94 with a touch gesture.

At S208, the selected first term 94 may be used to populate the magnet 46 or a new magnet 48, with a suitable gesture, such as a two-finger gesture (FIG. 7).

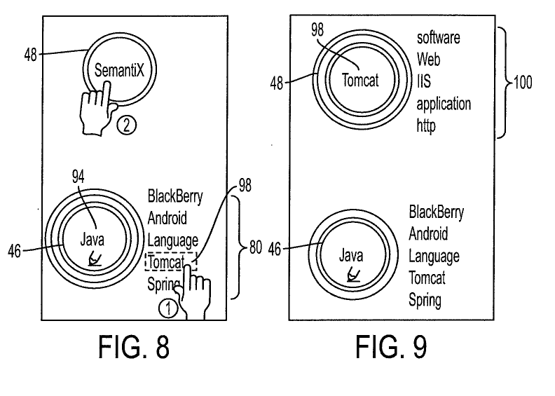

At S208, a set of one or more semantic terms 80 (FIG. 8) that are predicted to be semantically-related to (e.g., similar to) the selected first term 94 is identified, by the semantic similarity component 62, using the (selected) model 26 and/or 27. The semantically-related terms 80 are terms in the training collection 18 and/or 20 that have similar multidimensional representations, output by the semantic model, to that of the first term 94. The semantic terms 80 are caused to be displayed on the display device (FIG. 8). This may be performed automatically, or in response to a touch gesture on the magnet 46. The semantic terms 80 may be displayed as a cloud, a list, dropdown or scroll menu, or the like. The user may deselect (or erase or remove) some semantic terms 80 that are not of interest, for example, with a horizontal swipe-to-the-right or swipe-to-the-left gesture, which may cause additional terms to be displayed in replacement, such as other semantically-related terms but with a slightly lower similarity to the first term 94. Alternatively, a vertical top-down swipe gesture on the semantic terms 80 can cause all the terms to be replaced by the next most semantically-related terms, while a vertical bottom-up swipe gesture on the semantic terms 80 will bring back the deleted terms. In one embodiment, the list of semantic terms 80 only includes semantically-related terms which have a potential to influence the search results, for example, because they appear in one or more of the represented search documents. In another embodiment, the semantic terms 80 which have a potential to influence the search results are highlighted to indicate that they are present in one or more documents from the search collection 20.

At S210, provision is made for the searcher to select one or more of the displayed semantic terms 80 and populate a magnet, such as a new magnet 48, with the selected term(s) 98, e.g., by tapping on the magnet with one finger while tapping on the selected term with another (FIGS. 8 and 9). The population of the magnet 48 results in the association, in memory, of the magnet 48 with the selected semantic term 98, or with a query based thereon.

At S212, the selected semantic term 98 is displayed on the magnet 48. Once the magnet has been populated, it can be used for querying (S214). The different retrieval functions that the semantic query magnet 48 can be associated with can be the same as for keyword searches, and may include “positive” document filtering” i.e., any rule that enables documents to be filtered out, e.g., through predefined keyword-based searching rules. Responsive documents are identified that contain at least one occurrence of the semantic term associated with the semantic query. The occurrence may be a perfect match, partial match, inflexion, derivative, linguistic extension, combinations thereof, or the like, depending on the predefined keyword-based searching rules. In one embodiment, the semantic magnet can be used to modify the search, e.g., to narrow the search by using a combined AND search with terms of the two magnets 46, 48 on the sub-set of documents represented by tiles 56. In another embodiment, it may be used to perform an OR search to retrieve additional documents based on the term 98. In one embodiment, the selected term 98 may be used to perform a new search using only the magnet 48. Examples of methods for performing such functions using touch gestures are described, for example, in above-mentioned U.S. Pat. Nos. 8,165,974, 8,860,763, 8,756,503, and 9,405,456, by Caroline Privault, et al., incorporated herein by reference.

A new set 100 of similar terms may be displayed on the TUI, adjacent the magnet displaying the selected term 98, as described for S208. In this way, the searcher is provided with new search terms, which may not have appeared in any of the documents reviewed so far, or may not have been noticed by the searcher, encouraging the searcher to explore these new terms, if deemed useful to the search.

As illustrated in FIGS. 8 and 9, when a magnet is activated (populated with a query) it may change in appearance (illustrated schematically by additional rings on the magnet, although in practice, the magnet may stay the same size while appearing to glow).

As will be appreciated, the method can return to one of the earlier steps based on interactions of the user with the magnet(s), with additional magnets or with the graphic objects/displayed documents. Additionally, the user has the opportunity to populate additional magnets to expand the query, park responsive documents for later review in a document queue, and/or perform other actions as provided by the system.

The method illustrated in FIGS. 2 and 3 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use. The computer program product may be integral with the computer 14, (for example, an internal hard drive of RAM), or may be separate (for example, an external hard drive operatively connected with the computer 14), or may be separate and accessed via a digital data network such as a local area network (LAN) or the Internet (for example, as a redundant array of inexpensive or independent disks (RAID) or other network server storage that is indirectly accessed by the computer 14, via a digital network).

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphics card CPU (GPU), or PAL, or the like. In general, any device, capable of implementing a finite state machine that is in turn capable of implementing the flowchart shown in FIGS. 2 and 3, can be used to implement the method for assisting searchers to perform semantic searching. As will be appreciated, while the steps of the method may all be computer implemented, in some embodiments one or more of the steps may be at least partially performed manually. As will also be appreciated, the steps of the method need not all proceed in the order illustrated and fewer, more, or different steps may be performed.

Further details of the system and method will now be described.

### Semantic Relatedness Via Word Embedding (S104, S108)

“Semantic Relatedness” is a measure, over a set of documents or terms, of how much they relate to each other, based on the likeness of their meaning or semantic content. It aims to provide an estimate of the semantic relationship between units of language, such as words, sentences or concepts. In the domain of information-seeking and retrieval, a “semantic search” focuses on obtaining more relevant search results by searching on meaning rather than searching solely based on words. The exemplary semantic search method based on semantic relatedness thus goes beyond simple keyword searching, aiming at retrieving information by focusing broadly on the search context and the searcher's intent. It is particularly suited to performing exploratory searching on textual data.

NLP systems traditionally treat words as discrete atomic symbols. These encodings are arbitrary and generally provide no useful information regarding the relationships that may exist between the individual symbols. Representing words as unique, discrete IDs can lead to data sparsity, and usually means that more data is needed to train statistical models successfully. Using vector representations can overcome some of these obstacles. Vector space models (VSMs) provide a method for representing text documents as vectors where words are embedded in a continuous vector space in which semantically similar words are mapped to nearby points. They rely on the Harris Distributional Hypothesis in which words that appear in the same contexts share semantic meaning.

Suitable methods which can be used for word (or term) embedding include count-based methods (e.g., Latent Semantic Analysis), and predictive methods (e.g., neural probabilistic language models). Count-based methods compute the statistics of how often a given word co-occurs with its neighbor words in a large text corpus, and then maps these count-statistics down to a small, dense vector for each word. Predictive models, in contrast, attempt to predict a word from its neighbors in terms of learned small, dense embedding vectors (considered parameters of the model).

The exemplary method uses a predictive model and represents queries as multidimensional vectors output by a semantic relatedness model 26, 27, such as a neural network model or statistical model. As an example, a modeling approach as described by Mikolov, et al. may be employed (see, Mikolov, et al., “Efficient estimation of word representations in vector space,” arXiv preprint arXiv:1301.3781, 2013; Mikolov, et al., “Linguistic regularities in continuous space word representations,” HLT-NAACL, pp. 746-751, 2013; Mikolov, et al., “Distributed representations of words and phrases and their compositionality,” Advances in neural information processing systems, pp. 3111-3119, 2013; and above-mentioned U.S. Pat. No. 9,037,464). The word embeddings are used to build off-line one or more semantic language models 26, 27 that can be afterwards deployed to obtain on-line the semantic information on input terms, e.g., to compute the level of similarity between the input term and a set of document terms, to provide a list of most semantically related terms given the input term. Other semantic relatedness techniques useful herein can employ other methods, such as statistical modelling and natural language processing (NLP), categorization, and/or clustering. In the model 26, 27, each term is represented by a multidimensional vector, such as a vector having at least 10, or at least 20, or at least 50, or at least 100, or at least 200 dimensions (features), and in some embodiments, up to 10,000 or up to 1000 dimensions, such as about 500 dimensions. It is assumed that terms with similar multi-dimensional vectors are semantically similar.

As an example, Google's word2vec modelling and software tool (https://code.google.com/archive/p/word2vec/) can be used for single word embedding and/or embedding of longer terms. An open-source toolkit version of Word2vec is distributed under Apache License 2.0, (see https://code.google.com/archive/p/word2vec/). This is a computationally-efficient predictive model for learning word embeddings from raw text. The model, based on that described in U.S. Pat. No. 9,037,464, identifies a plurality of words that surround a given word in a sequence of words and maps the plurality of words into a numeric representation in a high-dimensional space with an embedding function (a neural network) that is learned to optimize the probability that similar terms have similar embeddings. The embedding function includes parameters which are learned during training. In particular weights of a neural network hidden layer are updated by back-propagation. Given embeddings of two terms generated with the learned semantic model, a score is computed which represents the similarity between their numeric representations. The numeric representations may be continuous representations represented using floating-point numbers. The relative positions of the representations in the multidimensional space may reflect syntactic similarities as well as semantic similarities between the terms represented by the representations.

In addition to supporting multi-word input or phrases, the exemplary semantic model can also return multi-word terms (or phrases) in the list of the most similar terms. A default value of, for example, 10, can be used as the maximum number of related words to return during a query and/or to display to the user. This threshold may be tuned in a static configuration or on-the-fly.

The similarity may be computed using any suitable similarity measure for determining vector similarity, such as the cosine similarity.

The word2vec tool provides two learning models: the Continuous Bag-of-Words (CBOW) and the Skip-Gram model. The CBOW predicts target words e.g. ‘mat’) from source context words (e.g. ‘the cat sits on the’). The Skip-Gram predicts source context-words from the target words. See, for example, Xin Rong, “word2vec Parameter Learning Explained,” arXiv:1411.2738, 2016, for a description of parameter learning for these two models. In the examples below, the CBOW model is used.

In another embodiment, a count-based method is used in which the embedding of each of a set of terms is based on a sparse vector representation of the contexts in which the considered term occurs in the training collection 18, 20. In this embodiment, each context corresponds to a respective one of a set of terms occurring in the training collection. Each sparse representation may include a number of dimensions, one for each of a set of terms in the training collection. The value of the dimension represents a number of times that the considered term co-occurs with that term in the documents of the training collection. Terms which occur infrequently in the training collection (less than a threshold number) can be ignored in selecting the set of terms. The sparse vector representations are converted to multidimensional representations of the terms in a new feature space, of fewer dimensions, such as at least 10, or at least 20, or at least 100 dimensions (features), and in some embodiments, up to 10,000 or up to 1000 dimensions, such as about 500 dimensions. It is assumed that terms with similar multi-dimensional vectors are semantically similar.

Prior to generating the model 26, 27, the training datasets 18, 20 may be preprocessed to generate a preprocessed document collection, e.g., by converting all texts to lower case, and/or removing special characters, xml and xhtml tags, image links, graphics, tables, etc. The considered context of a given word (or term) may be limited to the n preceding (and/or following words) to the given word, where n is a number which may be, for example, from 1-100, such as up to 20, or at least 2, e.g., 10. This allows detection of terms that are longer than one word. To provide a generic model 26, suited to use in a variety of applications, a large amount of data collected from various sources and various domains is employed, such as at least 5000, or at least 10,000, or at least 100,000 training documents and/or at least 40,000, or at least 100,000 contexts. Alternatively or additionally, a more specific semantic model 27 can be built on a much smaller scale using the search collection itself, in order to capture the contextual information related to the terms of the documents within the search collection.

The semantic language models 26, 27 can then be deployed to obtain the semantic information on input terms, for example, getting the level of similarity between two selected words or phrases, or finding lists of most semantically related terms given an input word.

### The User Interface

The illustrated TUI 12 is designed for assisting knowledge workers in document reviews. An example TUI is described in Privault, et al., “A New Tangible User Interface for Machine Learning Document Review,” Journal of Artificial Intelligence and Law (JAIL), 18 (4): pp. 459-479, 2010; Xerox, “Inside Innovation at Xerox: Smart Document Review Technology Puts Millions of Documents at your Fingertips,” and above-mentioned U.S. Pat. Nos. 8,860,763, 8,756,503, and 9,405,456, collectively referred to herein as Privault.

In the example system described in Privault, the user can load a collection of documents that is displayed in the interface 12 in a “wall view,” where each document is represented by a tile on the wall. The user can explore the data set by using unsupervised text clustering, text categorization, automatic term extraction and keyword-based filtering. When the user locates a sub-set of documents that seem worth further reviewing, the user can send the document sub-set to a dedicated area and switch to a document view. In the document view, documents tiles are queued and can be opened by the user on a simple tap. Documents may open in standard A4 format, just like a paper sheet for ease of reading. The user can review them one by one to decide which documents are relevant (or “Responsive”) to the search, and which ones are non-relevant (“Non Responsive”), or use other forms of manual classification using two or more classes. Touching a “relevant” tab 110 (FIG. 6) on a document 92 can be used to tag that document and move it to a “relevant” container 112 and touching a “non-relevant” tab 114 will do the same but to a “non-relevant” container 116. The movement of the document is visualized on the display. Animated transitions are both intuitive and engaging, giving a better perception of the execution of complex processes.

To identify and locate potentially interesting data, the user can manipulate specific search widgets 46, 48. These first are populated with a term 94 chosen by the user. Then the user can move the magnet widget close to a group of documents (e.g., a cluster), which pulls out all the documents that hold the chosen term. The tiles representing these documents are attracted around the magnet which helps users to visualize quickly how many documents meet the selected search criteria. A recognized touch gesture, such as swipe on the group of document tiles gathered around the magnet, can be used to cause a random sample of documents to be automatically opened. The user can read one or more of these to decide if the subset is worth inspecting further. To review the subset, the user can move the document subset from the magnet location to a document dispenser 118 (FIG. 6) through a recognized gesture, such as a 2-hand gesture. The dispenser 118 releases the documents one by one onto the screen, in response to a recognized touch gesture.

The search widgets can be populated in a number of ways such as:

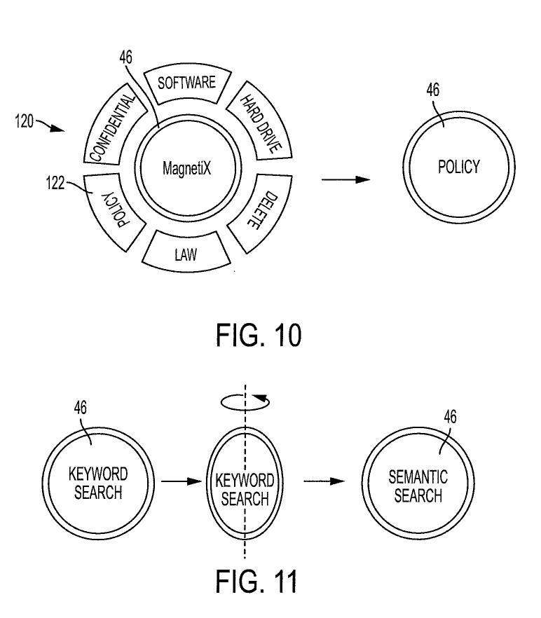

1. Static keywords. For example, as illustrated in FIG. 10, a recognized touch gesture, such as a tap on a magnet 46, 48 opens a wheel menu 120 which displays user-predefined terms 122. Another tap on a term causes the term selection, then closes the magnet menu 120 and populates the magnet with the chosen term that appears on top of the magnet widget.

2: Extracted keywords. A user can choose among keywords automatically extracted from each document cluster by a clustering algorithm (or named entities). These may be displayed on the TUI (FIG. 8). For example, the user touches one of the terms listed with one finger and subsequently touches a magnet widget with another finger. The TUI displays the user-selected term navigating to the magnet widget and then being displayed on top of the widget (FIG. 9).

3. Highlighted keywords. When reading a document displayed in paper format on the tabletop (in “Document View”), the user can directly highlight some text segments with his/her finger: the user can either select a single word through a single touch on a word within the document; or can run a finger over a phrase, from right to left or left to right; when releasing his/her finger from the document, the user can see a magnet popping-up next to the document, with the selected text appearing now on top of the widget (FIG. 6).

4. Semantically-related terms, which are generated using the semantic model and are displayed on the display.

The TUI facilitates iterative lookup search and exploratory search, and provides the user with a convenient mechanism for switching from one mode to the other.

In an iterative search phase, the user may perform a manual classification, by reviewing retrieved documents 92, e.g., by tapping on a virtual document dispenser 118, which releases the documents one by one, then opening, reading, and tagging documents to transfer them to a relevant or non-relevant bucket 112, 116 (FIG. 6).

In an exploratory search phase, the user may expand the search to new areas of the document collection or to groups of data, using, for example, text clustering, categorization, and/or term-based filtering. In a clustering operation for example, the tiles representing the documents are automatically grouped into sub-sets, e.g., with different colors for the tiles.

Users do not need to empty the document dispenser 118 and review all the stacked documents before moving to new sets of documents. At any time, the user can interrupt an iterative search phase, and switch to an exploration phase. This may occur as the review session unfolds and documents are read and labeled by the user. Knowledge is acquired and new information is discovered; interest drifts occur that can lead to new exploration phases and which are facilitated by the system, due to the TUI interaction and the semantic search functions.

A variety of exploratory search techniques may be supported, such as search via dynamic text selection or clustering, and also on-line text classification. In the present case, semantic relatedness is used to increase the level of exploration of the data in an efficient and intuitive way.

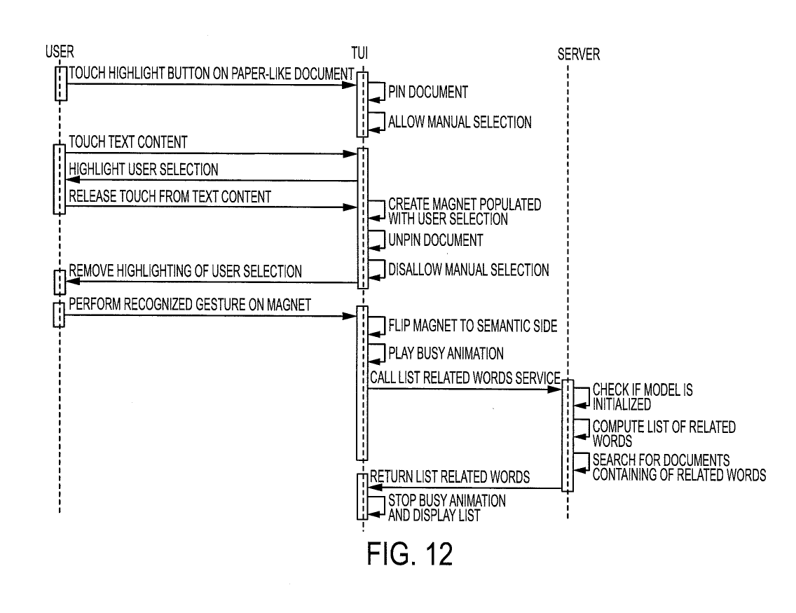

As illustrated in FIG. 11, a user may activate a semantic search phase by flipping the same magnet 46 used in keyword searching (or flip from semantic searching to keyword searching). For example, in the keyword mode, the user selects a word, phrase or text fragment to populate a magnet, then the magnet can operate in standard mode (i.e., it looks for simple matches of the selected term within documents of the search collection). The user can easily flip to the semantic relatedness mode. A flippable magnet as illustrated in FIG. 11, has two (or more) sides, each side corresponding to a different type of search. The keyword side performs standard content matching between user's input and documents' contents, while the semantic side is used to perform online requests to the semantic model 26, 27 in order to expand the search. One of the sides, such as the keyword side, may be used as a default side. To flip the magnet to its other side, the user may perform a recognized gesture, such as a two-finger single tap gesture or swipe on the widget. Another two-finger tap flips the magnet back to its original side. Only one side is displayed at a time and the functions of the magnet are those corresponding to the displayed side. FIG. 12 illustrates the progress of an example search.

Once the magnet is populated and flipped to its semantic side, the system computes, on-the-fly, the list of semantically related terms to form an expanded query. A change in appearance, such as an animated glow effect on the widget, indicates that it is ready for searching for new documents. When moved close to a group of documents, the magnet attracts all documents that match one or several of the terms from the expanded query. The searcher can choose to inspect the retrieved documents further by sending them to the document dispenser for a systematic review. The semantic magnet can also be applied to other groups of documents to locate other sources of information in the data space.

The list of semantically related words 80 is displayed next to the magnet that operated the query (FIG. 8), so that the searcher can instantly visualize and access them. Users can scroll and select items, each item showing a related word. The displayed items may be ranked by distance, e.g., the item displayed at the top is the one most similar (as determined by the model 26, 27) to the input word used for populating the magnet, and so on. When the user drags the magnet to another location on the touchscreen, the list stays close to the magnet and follows its movement.

As the items displayed in the list of semantic terms 80 are also selectable, they can be used in turn for populating a new magnet 48. This allows a new query to be launched and also to identify other semantically related terms computed on-the-fly by the model (FIG. 9), enabling sequential semantic searches to be run.

Technology-Assisted Review tools, such as the exemplary apparatus, find application in various domains. They can be applied to many real world situations and embedded in a range of industrial applications and services such as electronic discovery, human resources, technology watch, security, intellectual property management, and the like.

The system and method provide several advantages including: support and encourage exploratory search in a review system; increased learning from the data space; making semantic relatedness techniques available to all users and especially non-technical users, in a simple, generic and effective way; addressing the text entry challenge inherently associated with query formulation in TUIs and semantic search, and facilitating sequential search in a review environment.

These advantages are achieved by one or more of: use of a semantic relatedness model; providing exploratory review workflow in a tangible environment; and use of reversible magnet widgets.

For the users (in addition to saving time and work), these can result in higher usability, less training, acceptance of the system and higher satisfaction. More specifically, the system assists the user in finding an appropriate balance between exploration search and lookup iterative search. Because users follow mixed strategies of searching, and alternate between exploration and lookup phases, favoring exploration can help to retrieve more diverse topics (in exploration phases), and an increase of the level of exploitation will help retrieving narrower results (in lookup phases).

The text entry challenge associated with semantic search is that searches performed on traditional interfaces require frequent text entry and text manipulation to formulate queries. Text manipulation on touch devices is made difficult by the absence of physical keyboard, with soft-keyboards being clumsy and rather slow to use. In the exemplary system, efficient text entry is enabled by the reuse of existing text through natural hand gestures (e.g., by selection from open documents, information displayed on the touch screen, or terms displayed in magnet menus), to exploit the generic semantic model (and/or specific semantic models).

### Example of Exploratory Search in Legal Review

An example illustrating the use of exploratory search is in legal review, where document reviews are conducted as part of eDiscovery processes in litigation. In response to a request by one party, the other party has to review often large collections of documents in order to produce all documents that are potentially responsive to the discovery request.

The execution of the task is typically governed by a protocol and planning stage documents, that provide background information (high level statement of the review objectives in connection with the specified litigation), and procedures for reviewing documents (review guidance document).

The review guidance document tries to give as much detail as possible to the review team, although in practice the elements can be rather limited. For example, examples are provided of what constitutes relevance or responsiveness. Examples of what reviewers should search for may be in the form of short sentences such as: “Communications suggesting improper use of . . . ,” “Any reference that a risk . . . ,” accompanied with an initial list of keywords. These instructions are often presented as ‘guidelines only,’ that can be subject to revision as the review progresses.

In practice, lawyers build their own theory of the case and mental impressions of how to find relevant information. Based on these, they develop personal thought processes and legal techniques to find documents that are responsive to the request for production. It is common practice for them to work at developing their own list of keyword and search terms in relation to the case, while being aware that search term lists are often not enough to characterize the responsiveness nature of the documents and that it can produce many false positive and negatives.

The legal review process thus benefits from exploratory search since the task description is often ill-defined, the task is dynamic, and searchers have latitude in directing their search. Lawyers are assisted by the system in expanding their search during the review by dynamically suggesting new system-generated semantic terms 80, 100. This approach is human-driven: when a reviewer focuses on a keyword 94, 98 to search for documents, the system uses the focused keyword to retrieve new terms based on their degree of semantic relatedness. The new terms are displayed, (i.e., semantically related terms as computed by the system), but human intuition and understanding of the case by the reviewer are used to choose the ones to use for searching other documents. The reviewer can discard the proposed terms, change focus to other keywords or ask for other semantically related information.

Without intending to limit the scope of the exemplary embodiment, the following Examples demonstrate application of the method.

### Examples

### 1. Building a Semantic Model

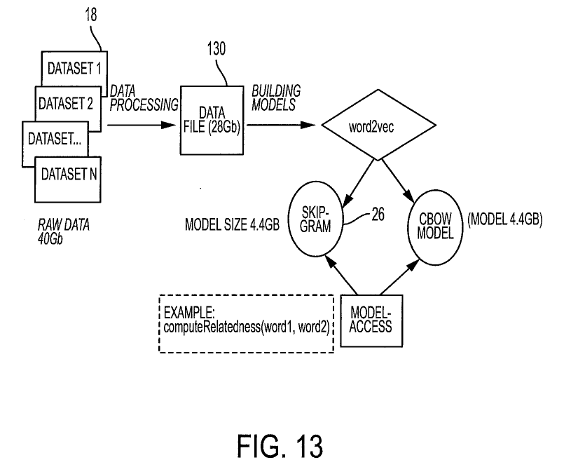

With reference to FIG. 13, a large set of data 18, was collected from different application domains using the following sources:

1. The training monolingual news crawl in 2012 and 2013 of the 9^{th} Workshop on Statistical Machine Translation (http://www.statmt.org/wmt14/translation-task.html).

2. The 1-billion-word language model benchmark. See, Chelba, et al., “One billion word benchmark for measuring progress in statistical language modeling,” arXiv preprint arXiv:1312.3005, 2013, 15th Annual Conf. of the Intl Speech Communication Association (INTERSPEECH), pp. 2635-2639, 2014. The dataset is accessible at www.statmt.org/Im-benchmark/1-billion-word-language-modeling-benchmark-r13output.tar.gz.

3. The UMBC WebBase corpus: a dataset of high quality English paragraphs containing over three billion words derived from the Stanford WebBase project's February 2007 Web crawl. See, L. Han, et al., “UMBC Ebiquity-Core: Semantic textual similarity systems,” Proc. 2nd Joint Conf. on Lexical and Computational Semantics, vol. 1, pp. 44-52, 2013. The dataset is available at http://ebiquity.umbc.edu/redirect/to/resource/id/351/UMBC-webbase-corpus.

4. A recent Wikipedia dump file (https://en.wikipedia.org/wiki/Wikipedia:Database_download).

The total size of this dataset is about 40 GB. As the data comes from different sources with different formats, some pre-processing was applied to generate a processed corpus 130 before building the model as follows: first, all text was converted to lower case, and special characters were removed. For the Wikipedia data, only the body text in between <text> . . . </text> tags was kept, (removing REDIRECT, xml tags, references <ref> . . . </ref>, xhtml tags, image links, decode URL encoded chars, URL and URL encoded chars, icons, tables, etc.). This resulted in a pre-processed dataset of 28 GB.

A semantic model 26 was generated using the Google's word2vec (including word2phrase) toolkit to generate uni-grams and n-grams from the pre-processed data. The SkipGram model and Negative sampling of the toolkit were used, as proposed by T. Mikolov, et al., “Distributed representations of words and phrases and their compositionality,” NIPS, pp. 3111-3119, 2013.

The semantic model was built using the following parameters: CBOW=0; negative=10; size=500; window=10; hs=0; sample=1e-5; threads-40; iter=3; min-count=10. A semantic model 26 of 4.4 GB was obtained.

The window is the maximum distance between the current and predicted word within a sentence. The size is the number of dimensions in the multidimensional vector. CBOW=0 indicates that the CBOW algorithm is not used and that SkipGram is used instead. If hs=1, hierarchical softmax is used for model training. If set to 0 (default), and negative is non-zero, negative sampling is used. iter is the number of iterations (epochs) over the corpus. sample is a threshold for configuring which higher-frequency words are randomly downsampled (typically selected from the range (0, 1e-5). min_count means ignore all words with total count in the training set of lower than this, and can be varied based on the size of the training collection. threads indicates the number of parallel processing cores used to train the model, and affects the speed of learning. A large number of threads, (such as—100 on a server, or thousands of threads in a distributed computing environment), can speed up the learning considerably. The model is initialized from an iterable list of sentences from the training data. Each sentence is a list of words (unicode strings) that are used for training.

A large amount of non-specific data was thus used to obtain a large generic model that can potentially support the goals of searchers in general; however, when needed, dedicated models could also be built from domain-specific data sets, either from public sources, or from client data 20. For example, in healthcare or pharmaceutical domains, or for car manufacturing, etc. Specific semantic models 27 can even be used to complement generic semantic models 26.

Semantic relatedness capabilities are provided by a java library which handles SkipGram as well as CBOW-generated models. The library allows the user to: a) load a semantic model 26, 27 in the memory; b) choose a term and query the model in order to get a list of the most related words/phrases; and c) compute the semantic relatedness score between two words.

The semantic relatedness model 26 or 27 can be very large and accessing the model can take significant time. To make sure users can access it in real-time in the course of a search session, it may be loaded in memory at application start-up. Model loading can take a few minutes, (e.g., up to about 6 mins for the 4.4 GB model on an ordinary computer with 8 GB ram), while computing the similarity score between 2 words takes less than a second, and On a smaller model, for example, a 100 Mb model 27 dedicated to the “software engineering” domain, model loading may take only a few seconds.

### Evaluation of Semantic Model

For model evaluation, in addition to using the word analogy test provided by Google, the model was tested on the task of computing the semantic similarity/relatedness between words to evaluate the model's capability of finding semantically related words to be used in a semantic search.

The evaluation data were built from several datasets:

1. MC30 (Miller, et al., “Contextual correlates of semantic similarity,” Language and cognitive processes, 6(1) 1-28, 1991).

2. RG65 (Rubenstein, et al., “Contextual correlates of synonymy,” Communications of the ACM, 8(10) 627-633, 1965),

3. MTurk (Radinsky, et al., “A word at a time: computing word relatedness using temporal semantic analysis,” Proc. 20th Intl Conf. on World wide web, ACM, pp. 337-346, 2011).

4. Word-Sim353 Similarity and Relatedness (Agirre, et al., “A study on similarity and relatedness using distributional and Wordnet-based approaches,” Proc. Human Language Technologies: The 2009 Annual Conf. of the NAACL, pp. 19-27, 2009).

The evaluation data contained 837 word pairs in total, with human annotation for semantic similarity and relatedness. However, since these datasets were developed and annotated by different people and annotation guidelines, the semantic similarity/relatedness scores were specified in different scales. Thus the annotation scores were normalized to the range [0-1] by feature scaling (data normalization).

For evaluation metrics, the Pearson product-moment correlation and Spearman rank correlation coefficient correlation methods were employed. TABLE 1 shows the results of the model evaluation on different settings of datasets.

TABLE 1
Result of semantic model evaluation

| Dataset | Pearson, r | Spearman, rho |
|---|---|---|
| ALL | 0.65045 | 0.6699 |
| MC30 | 0.7904 | 0.7835 |
| RG65 | 0.7614 | 0.7626 |
| MTurk | 0.7020 | 0.6738 |
| WordSim353-Sim | 0.6696 | 0.7183 |
| WordSim353-Rel | 0.5147 | 0.5386 |

The results indicate that the semantic model obtains good results on several datasets, when compared to other models for which results have been reported on the ACL Wiki pages for “Similarity (State of the art)”.

The method was also evaluated in a legal context using a specific model 27 generated from the The TREC 2010 Legal Track Learning Task. See, Cormack, G. V., et al., “Overview of the TREC-2010 Legal Track,” Working Notes of the 19th Text Retrieval Conf., pp. 30-38, 2010. The full document collection was a variant of the Enron email corpus comprising 685,592 documents that were used for building the semantic model. 1000 documents were subsampled to be subject to responsiveness review by the system. For creating a mix of responsive and non-responsive documents, documents were subsampled from both categories as follows: for the non-responsive ones, 814 documents consisting of emails related to topics such as human resources, corporate announcement, personal (entertainment, family, trips, etc.) were collected; for the responsive data, 186 emails released by the U.S. Department of Justice (DOJ) which were coded and produced by legal experts to represent different aspects of the data set with respect to the case were used. As expected, these emails cover several types of responsive documents. The 1000 documents for the review session were loaded on the TUI, while the approximately 700,000 other documents were used off-line to prepare the semantic model. Preprocessing included removal of MIME types, hash-id of email users, URLs, etc. Then the word2phrase tool (from word2vec) was applied to generate the corpus phrases (n-grams). In a post-processing stage, some remaining hash-id from email users were filtered out. The semantic model was generated using the combination of SkipGram and Negative Sampling as described above.

The model was evaluated using five search terms (keywords) specifically chosen in relation to the case. Two of these, trade and trading were close terms. Each keyword was used to retrieve a set of documents. Each keyword was also used to query the semantic model and the top terms returned by the model for each of them were obtained. The proposed top terms were then used for searching for new documents and the number of responsive document hits were determined. All of the keywords generated new terms (semantically related) which increased the number of responsive documents retrieved, except for “trading”. (The semantically related terms generated for “trading” did not help retrieving more responsive documents, while the ones generated from keyword “trade” did. This particular case suggests that using the stem rather any morphological variant of a stem will help in retrieving more information). Even though the new terms retrieved were not always well-formed, using these raw terms for document searching and avoiding extensive preprocessing of the training data was found to be beneficial for retrieval of relevant documents.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for dynamically generating a query comprising:
providing a virtual widget which is movable on a display device of a user interface in response to detected user gestures on or adjacent to the user interface;
displaying a set of graphic objects on the display device, each of the graphic objects representing a respective text document in a search document collection;
providing for a user to populate the virtual widget with a first query term;
with a processor, identifying a set of semantic terms that are predicted to be semantically related to the first query term, based on a computed similarity between a multidimensional representation of the first query term and multidimensional representations of terms occurring in a training document collection, the training document collection comprising documents from at least one of the search document collection and another document collection, the multidimensional representations having been output by a semantic model which takes into account context of the respective terms in the training document collection;
providing for a user to select one of the set of semantic terms to create a semantic query;
identifying documents in the search document collection that are responsive to a semantic query that is based on the selected semantic term, the identified documents including documents containing at least one occurrence of the semantic term associated with the semantic query.

2. The method of claim 1, further comprising populating a virtual widget with the semantic query, based on the semantic term.

3. The method of claim 1, wherein the semantic query includes at least one of:
positive document filtering to identify documents in the search document collection that are responsive to the semantic query,
identifying similar documents to a document responsive to the semantic query;
classification of documents in the search document collection based on responsiveness to the semantic query;
a combined query based on the semantic query and another query, the semantic query and the other query being used to populate respective virtual widgets displayed on the display device.

4. The method of claim 1, wherein the identifying documents comprises causing at least one of:
at least a subset of the displayed graphic objects to exhibit a response to the virtual widget that is populated with the semantic query, as a function of the semantic query and text content of respective documents which the graphic objects represent; and
a text fragment responsive to the semantic query to be highlighted in one of the documents in the search document collection.

5. The method of claim 4, wherein causing a subset of the graphic objects to exhibit a response to the widget is based on a function of an attribute of each of the documents represented by the graphic objects in the subset.

6. The method of claim 1, further comprising generating the semantic model.

7. The method of claim 1, wherein the semantic model comprises a neural network which outputs the multidimensional representations.

8. The method of claim 1, wherein the semantic model comprises at least one of a word2vec and a word2phrase semantic model.

9. The method of claim 1 wherein each of the multidimensional representations includes at least 50 dimensions.

10. The method of claim 1, wherein the providing for a user to populate the virtual widget with a first query term comprises at least one of:
displaying a set of candidate query terms on the display device, recognizing a user gesture as selecting one of the candidate query terms as the first query term, and associating the first query term in memory with the virtual widget;
providing for a user to input a query term with a user input mechanism; and
recognizing a highlighting gesture on the user interface over a displayed one of documents in the search document collection as a selection of a text fragment from text content of the document and populating the virtual widget with a first query term which is based on the selected text fragment.

11. The method of claim 1, wherein the populating of the virtual widget with the semantic query comprises recognizing a user gesture, with respect to the virtual widget and the displayed selected semantic term, as generating a virtual bridge for associating a semantic query, based on the semantic term, with the virtual widget.

12. The method of claim 1, wherein the semantic model comprises a general semantic model generated from a general document collection and a specific semantic model generated from the search document collection, the method further comprising selecting one of the general semantic model and the specific semantic model.

13. The method of claim 1, wherein the virtual widget includes a first side which, in response to a recognized user gesture, causes graphical objects representing documents responsive to a first query based on the first query term to move, relative to the virtual widget, and a second side, which, in response to a recognized user gesture, causes graphical objects representing documents responsive to the semantic query to move, relative to the virtual widget, the virtual widget being flipped, between the first and second sides, in response to a recognized user gesture.

14. A method for combining explorative searching with iterative searching comprising performing the method of claim 1, the method further comprising retrieving documents from the search document collection that are responsive to the first query term.

15. A computer program product comprising a non-transitory recording medium storing instructions, which when executed on a computer, causes the computer to perform the method of claim 1.

16. A system comprising memory which stores instructions for performing the method of claim 1 and a processor, in communication with the memory, for executing the instructions.

17. A system for dynamically generating a query comprising:
a user interface comprising a display device for displaying text documents stored in associated memory and for displaying at least one virtual widget, the virtual widget being movable on the display, in response to user gestures relative to the user interface;
memory which stores instructions for:
generating a first query based on a user-selected first query term displayed on the display device, populating a virtual widget with the first query, and conducting a search for documents in a search document collection that are responsive to the first query; and
generating a semantic query, populating a virtual widget with the second query, and conducting a search for documents in the search document collection that are responsive to the semantic query, the generating of the semantic query including identifying a set of semantic terms that are predicted to be semantically related to the first query term, based on a computed similarity between a multidimensional representation of the first query term and multidimensional representations of terms occurring in a training document collection, the training document collection comprising documents from at least one of the search document collection and another document collection, the multidimensional representations having been output by a semantic model which takes into account context of the respective terms in the training document collection; and
a processor in communication with the memory which implements the instructions.

18. A method for dynamically generating queries comprising:
generating a semantic model comprising learning parameters of the semantic model for embedding terms based on respective sparse representations, the sparse representations each being based on contexts in which the respective term is present in a training document collection;
providing for a user to select a first query term using a user interface;
generating a first query based on the first query term;
displaying a first set of graphic objects on the user interface that represent documents in a search document collection that are responsive to the first query;
identifying a set of semantic terms, the identifying comprising computing a similarity between an embedding of the query term, generated with the semantic model, and embeddings of terms in the document collection, generated with the semantic model, the set of semantic terms comprising terms in the document collection having a higher computed similarity than other terms in the document collection;
generating a semantic query based on a user selected one of the set of semantic terms;
displaying a second set of graphic objects on the user interface that represent documents in a search document collection that are responsive to the semantic query;
providing a virtual widget which is movable on the user interface in response to detected user gestures on or adjacent to the user interface, the virtual widget having a first displayable side with which the user causes a search for responsive documents to be conducted with the first query term and a second displayable side with which the user causes a search to be conducted with the semantic query term, only one of the sides being displayed at a time.
